(19) United States
(12) Patent Application Publication
(10) Pub. No.: US 2010/0232093 A1
(43) Pub. Date: Sep. 16, 2010

(54) Mobile Power Supply

(75) Inventor: Timothy J. Kaminski, Atwater, OH (US)

Correspondence Address: George W. Moxon II;Roetzel & Andress, 222 South Main Street, Akron, OH, 44308, US

(73) Assignee: LOCKHEED MARTIN CORPORATION, Akron, OH (US)

(21) Appl. No.: 12/404,867

(22) Filed: Mar. 16, 2009

(51) Int. Cl. H02B 1/26

(52) U.S. Cl. 361/623

(57) ABSTRACT

A cord-connected mobile power supply which consists of a transformer for converting 480-volt power to 240-volt power and 120-volt power, a distribution panel means for providing over current protection to branch circuits, which have ground fault interrupter receptacles for connection of utilization equipment, which can be modified to accommodate different equipment requirements or GFI protection of branch circuits, and which has a transporting means consists of an adapted narrow L-shaped dolly frame with an extended platform having two wheels and handle.

### BACKGROUND OF THE INVENTION

The present invention relates to mobile power generation, more particularly to a mobile device for converting 480-volt power to 240- and 120-volt power.

Practically every electrical appliance requires 120-volt or 240-volt electricity to operate. A range of appliances has been developed to provide a power source at locations where it is either not practical and/or dangerous to be connected to mains power. One commonly used method involves the use of a fuel-driven generator. However, such generators are heavy, large, lack ready portability, are not practical for use in automobiles, caravans and boats, and the use of such devices when they are around hazardous, flammable material is dangerous.

Alternative and more compact forms of power sources are based on harnessing the sun's energy through solar panels. However, these systems are expensive, weather dependent, require sunlight, and may not necessarily produce sufficient current for particular needs. An innate problem with solar power systems arises from the fact that energy impact per unit of surface area is not sufficiently high to provide concentrated power generation.

Inverters are also available to invert low direct current (“DC”) voltage such as around 8-12 volts to alternating current (“AC”) mains power levels, i.e. around 240-volts. However, such inverters are expensive and readily deplete the DC voltage power supply. Furthermore, the mains power output is dangerous to potential users, especially in inclement weather.

Conventional power supplies and/or generators include the Yamaha EF1000iS Generator. The EF1000iS Generator is a gasoline engine capable of providing maximum AC output of 1000 Watts of power on a continuous operation of 12 hours. However, it is gasoline operated, which emits fumes and possible pollution over time. The engine produces noise levels from 47 dBA at ¼ load up to 57 dBA at full load, and maintenance and repairs are necessary.

Another portable generator vendor is Briggs & Stratton. Briggs & Stratton portable generators are gasoline engine capable of providing AC output at various capacities. However, it is also gasoline operated, which emits fumes and possible pollution over time. The engine produces noise during usage. The unit is also bulky and requires relatively large space to operate. The generator's weight varies from 55 lbs up to 283 lbs. Additionally, maintenance and repairs are necessary.

Yet another vendor is Xantrex which markets the Portawattz 3000. The Portawattz 3000 is an inverter, which inverts 12 Volts from battery and converts the 12 Volts to a 115 Volts AC household power, with output power at 2500-Watts continuous with a 5000-Watts surge. However, the unit requires an external 12 Volt battery source to operate. It outputs only AC Power. Also, installation is required by hardwiring AC output to battery, and the inverter may require mounting as well. When connected to a vehicle, boat, or RV, constant running of the engine is necessary to provide 12-Volt power source and thus the unit is restrictively portable when operated with the vehicle. Further, certain unit requires forty or more hours to fully charge its internal rechargeable battery.

U.S. Pat. No. 5,381,328 teaches a PWM (pulse width modulator) inverter system having a sine (low-pass) filter. The sine filter includes a reactor and a capacitor, and is connected to the output of a PWM inverter. The instantaneous current flowing through the capacitor, and the instantaneous output current supplied from the sine filter to a load are detected. An instantaneous voltage command value is corrected on the basis of the detected current values. This makes it possible to limit oscillating waveforms involved in the output voltage of the PWM inverter without using a damping circuit, which was connected in parallel with the capacitor in a conventional sine filter. The capacitor of the sine filter may be composed of a plurality of capacitors connected in parallel, and this will serve to further reduce the size of the sine filter. In a parallel operation of a plurality of PWM inverters, a cross current, that is, the difference between an instantaneous output current command value and an instantaneous capacitor current command value is reduced by correcting the instantaneous voltage command value. This makes it possible to share the current assigned to each PWM inverter with high stability.

U.S. Pat. No. 6,624,635 discloses an uninterruptible power supply for use with an Internet Telephone or Internet Telephone Cable Modem. The power supply includes a power supply, a load, an AC/DC converter for producing converter DC, and a rechargeable battery. A DC output multiplexer selects one of such DC sources and furnishes it to the load. The multiplexer has an input control signal for switching the DC source to a battery, and an output indicator indicating when the battery is acting as the DC source. The load includes a controller which generates this test signal at times when it is useful to test the battery, and accepts the indicator signal to know when the battery is providing this current. The controller includes a test function for measuring the reserve charge of the battery by measuring the temporal voltage drop and time of this temporal voltage drop with the use of an A/C converter. Additionally, the controller measures the charge and discharge intervals of the battery. The controller includes non-volatile random access memory, which stores the test state, and an internet connection for the passage of messages to and from the internet.

U.S. Pat. No. 6,628,011 discloses a DC to DC (direct current) Converter including an electrical circuit that allows batteries and other electrical energy storage devices to be charged from or to discharge to a variable voltage DC bus. This electrical circuit also enables seamless integration with other energy storage devices and/or DC power sources, such as fuel cells, to provide DC power for a Power Management System. A Power Management System preferably provides both full power source management and power conditioning. The Power Management System is able to manage power flow to and from multiple, isolated, power sources and energy storage devices to deliver high quality alternating current (“AC”) power to a load.

U.S. patent application Ser. No. 20040012268 discloses a portable power converter with input means to receive low voltage DC input from an independent power source such as a 12-Volt battery or power pack through an input lead 16. This connection may be effected with alligator clips, adjustable ring clamps, or any suitable methods. The input lead is in turn connected to a low DC to high DC voltage power converter situated in a compartment of enclosure or housing. The enclosure or housing may have two or more compartments. One of the compartments may be formed by the walls of a container for the power converter where the container is fixed to a wall of the enclosure or housing.

### SUMMARY OF THE INVENTION

A cord-connected mobile power supply which consists of a transformer for converting 480-volt power to 240-volt power and 120-volt power, a distribution panel means, means for providing over current protection to branch circuits, which have ground fault interrupter receptacles for connection of utilization equipment, which can be modified to accommodate different equipment requirements or GFI protection of branch circuits, and which has a transporting means consists of an adapted narrow L-shaped dolly frame with an extended platform having two wheels and handle. The mobile power supply is capable of fitting into narrow workspaces and narrow walkways.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of the mobility system of the present invention;

FIG. 2 is a side view of the mobile power supply system of the present invention;

FIG. 3 is an opposite side view of the mobile power supply system;

FIG. 4 is a front view of the mobile power supply system; and

FIG. 5 is a top view of the mobile power supply system.

### DETAILED DESCRIPTION OF THE INVENTION

The uniqueness of the concept is the combined capability of the invention to simply and safely provide a variety of electrical power outlets in difficult to access locations where it currently does not exist using a portable power conversion device. The present invention provides a system that is re-useable and transportable, since it is easily installed by one person without special skills, and has the ability to quickly and easily provide safe, continuous power. The need is to provide 120-volt and 240-volt ac power for utility, maintenance and emergencies where only high voltage 480 volt power exists. The existing methodology requires individual designs, permits, electricians, and firmly mounted hardware to convert the power and provide proper safe distribution. This can be very time consuming and costly. This is especially costly and time consuming in hard to access areas like catwalks, tunnels, and vaults. The invention provides a simple, cost-effective, fast, safe, portable solution to the problem. Simple connection points can be prepositioned and the inexpensive distribution system moved from location to location as required. In most cases, the existing connection points are already in position for existing equipment; such as, fans, motors, etc. The present invention provides for the user to directly connect loads. It can provide access on catwalks, tunnels and vaults. The present system provides the ability to continuously provide significantly more power continuously.

The mobile power supply 10 of the present invention has four parts, namely a mobility portion, a power distribution (circuit breakers) portion, utilization (receptacles) portion, and a power conversion portion. The mobility portion or lift vehicle 11 is similar in structure to a hand truck and includes, generally, a vertical frame 12 which is made up of tubular members. The vertical frame 12 has a further structural member or center spine 50, which may be made from aluminum, steel or other appropriate construction materials and which extends vertically at the center back of the hand truck 11 and is attached to horizontal frame members 14 and 18 by a convenient attaching means such as screwing, bolting, welding, and the like. The spine means is a generally U-shaped (or channel shaped) structural member, which strengthens the mobility means (or cart) and provides support and means for connecting the power converting means to the mobility means. Attached at a generally perpendicular angle to the vertical frame 12 is a horizontal support means 20.

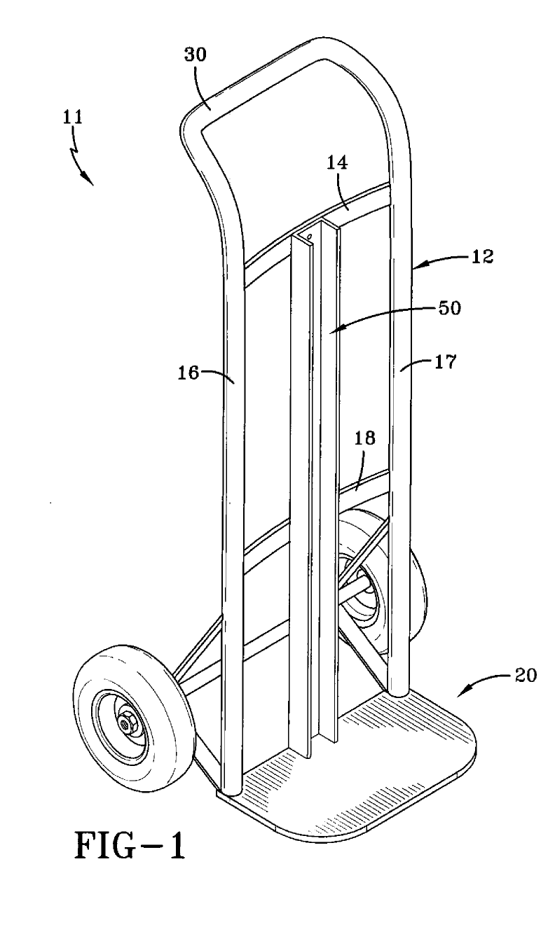

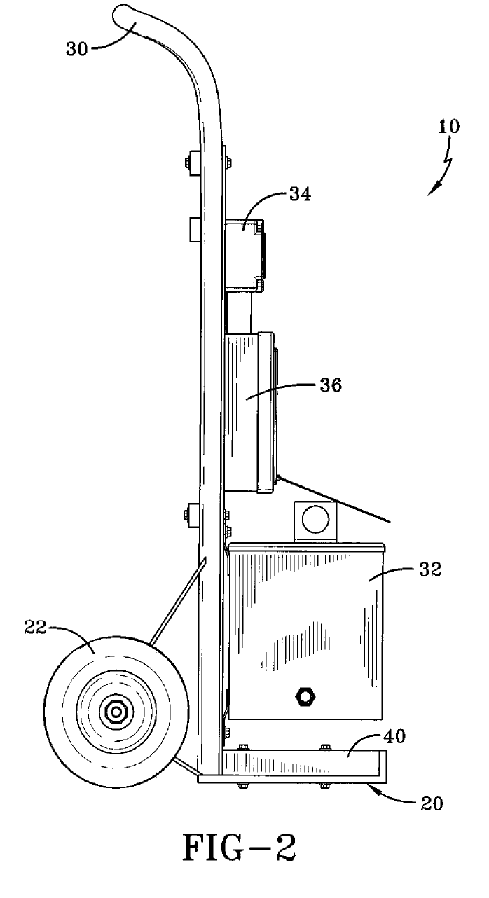

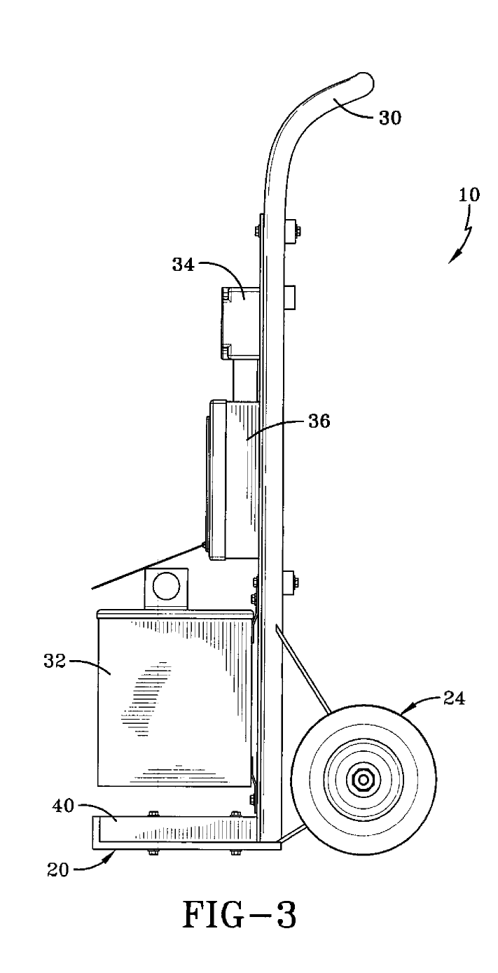

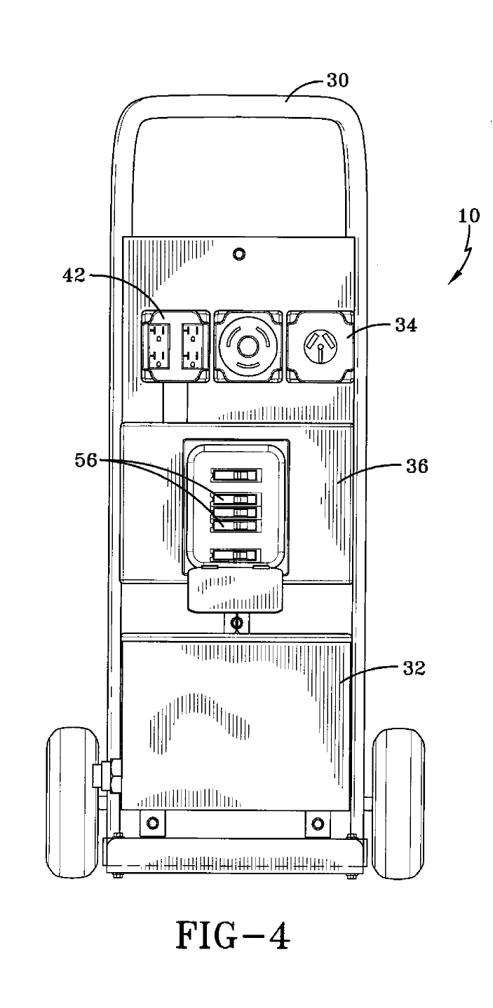

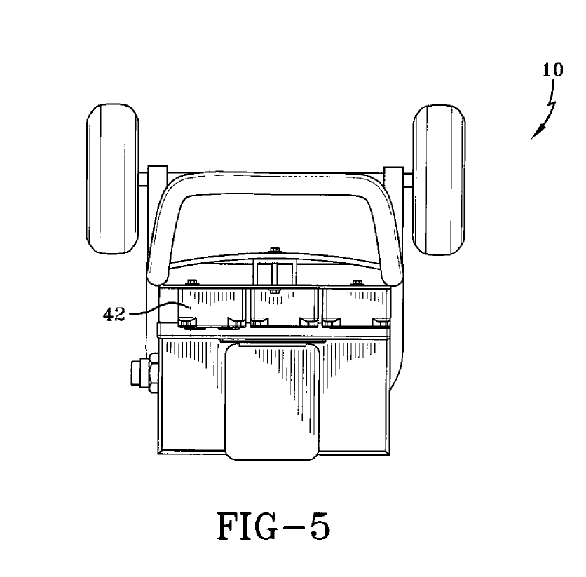

As seen in FIGS. 3-5, the power converting means is attached to the mobility means via a bolt 52 and nut 54. The spine rests on base 40, which provides a distribution of a significant portion of the weight of the power converting portion of the present invention and which is supported by load supporting member 20. The horizontal, load supporting structure 20 can be a generally straight member, as shown in FIG. 1, or can have an “L” shaped end as shown in FIG. 2 to form a lip on supporting member 20 so that base 40 can either extend beyond support member 20 or be contained by the lip and constrained from movement. Neither of these embodiments is critical to supporting the power converting means. Further, base 40 can simply rest of support member 20 or be affixed using appropriate fixing means, such as bolts and nuts, and the like. The vertical frame 12 is supported by a pair of supporting wheels 22 and 24, which are connected to the vertical frame 12 at the point where the load supporting structure 20 extends from the frame 12 by a wheel support structure 26 which holds the axle 28 joining the wheels. At the top of the vertical frame is a handle 30 for grasping the frame and moving the mobile power supply.

The width of the mobility system is chosen so that its size will fit in narrow spaces and passages found in tight work areas. The width will be less than about 20 inches, preferably 19 inches. This width will be determined by the wheels of the system. The wheels can be outside the frame, or coincident with the frame and thus located behind the frame. The wider wheel spacing is preferred since the wider wheels provide more lateral stability.

Mounted on the lift vehicle 11 is a 5 kw single-phase transformer 32, a distribution panel 36, which incorporates circuit breakers 36, and utilization means 34 which incorporate receptacle outlets 42 and ground fault interrupters (or GFI) breakers 56, which can be provided with a appropriate cover which can be hinged to swing into place to cover the breakers. The equipment employed may include lights, drills, vacuums, or any cord-connected utilization equipment. The ground fault interrupter receptacles or outlets 34 are used for providing power to utilization equipment; such as, lights, drills, vacuums, power tools, fans, other cord-connected utilization equipment, and the like. The transformer 32 is connected to a 480-volt power source via an appropriate plug (not shown) and line (not shown), or may have a receptacle to receive a line form a power source, and in turn, the transformer 32 is connected to a distribution panel 36, which has incorporated a circuit breakers 38 in the system. The transformer can be a Square D Model No. QO5S1F or the like. The circuit breakers can be Square D, Model No. QO120 or equivalent. The distribution panel can be a Square D, Model No. QO816L100DS or equivalent. The distribution panel 36 circuit breakers are connected to supply ground fault interrupters (not shown) that are incorporated in the outlets or receptacles 42 for plugs for 120 volt power requirements. The 120-volt GFI receptacles are Leviton Model No. LEV88991. If 240-volt power is required, then Square D circuit breaker Model No. QO220GFI will be used. The distribution panel and circuit breakers that supply ground fault interrupter receptacles can be easily modified depending on load and/or equipment requirements. The modifications can be achieved by changing the receptacles to accommodate the utilization equipment configurations. The circuit breakers may be changed to provide multi-pole GFI protection. The modification can be made using a screw driver to change the receptacles, covers, and breakers. To do so, first, one must shut off the power and remove the cover of outlet 42 and then replace the receptacle with another desired configuration, such as, a 230-volt receptable 34, and then change the breakers 56. As presently illustrated, outlet 42 is a 110-volt outlet, while outlet 34 is a 230-volt outlet. Thus, 480-volt power flows into the transformer via a power line 40, while 240 and 120-volt power flows from the transformer to the outlets 42 and 240-volt and 120-volt power flows from the transformer to the distribution panel to the outlets 42. Any equipment requiring a 120-volt power supply may be plugged directly into the ground fault interrupter outlets 42, while 240-volt power flows from multi-pole GFI protection.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What we claim is:

1. A mobile power supply comprising
A. transformer means for converting 480-volt power to 240-volt power and 120-volt power,
B. distribution means providing over-current protection and electrical access to 240-volt and/or 120-volt power, and
C. outlet means for providing power for utilization by equipment; and
D. means for transporting the voltage converter.

2. The mobile power supply of claim 1 wherein the means for transporting the voltage converter comprise an L-shaped frame having two wheels and a spine means for supporting the voltage converter.

3. The mobile power supply of claim 1 wherein the means for transporting the voltage converter comprise a frame made up from tubular members, having a support platform extending perpendicularly from the frame, having two wheels affixed to the frame where the support platform extends from the frame, and a vertical spine means for supporting the voltage converter.

4. The mobile power supply of claim 1 wherein the transformer is a 5 kw single-phase transformer.

5. The mobile power supply of claim 1 further incorporating a distribution panel and circuit breakers.

6. The mobile power supply of claim 1 wherein the outlets are ground fault interrupter receptacles or multi-pole ground fault interrupter breakers.

7. The mobile power supply of claim 1 wherein the means for transporting is less than 20 inches wide.

8. The mobile power supply of claim 1 wherein the receptacles are changeable to accommodate varying utilization equipment configurations.

9. The mobile power supply of claim 1 wherein the circuit breakers are changeable to provide multi-pole ground fault interrupter protection.
